(19) United States
(12) Patent Application Publication
(10) Pub. No.: US 2005/0204113 A1
(43) Pub. Date: Sep. 15, 2005

(54) METHOD, SYSTEM AND STORAGE MEDIUM FOR DYNAMICALLY SELECTING A PAGE MANAGEMENT POLICY FOR A MEMORY CONTROLLER

(75) Inventors: Richard E. Harper, Chapel Hill, NC (US); Chris Dombrowski, Cary, NC (US); Gregory J. McKnight, Chapel Hill, NC (US)

Correspondence Address: CANTOR COLBURN, LLP, 55 GRIFFIN ROAD SOUTH, BLOOMFIELD, CT, 06002, US

(73) Assignee: INTERNATIONAL BUSINESS MACHINES CORP., Armonk, NY (US)

(21) Appl. No.: 10/708,518

(22) Filed: Mar. 9, 2004

(51) Int. Cl. G06F 12/00

(52) U.S. Cl. 711/170; 711/154

(57) ABSTRACT

A method for operating a memory controller including receiving a current memory access request from an agent. A page management policy associated with the agent is determined in response to receiving the request. The memory controller is set to the page management policy associated with the agent and the current memory access request is executed on the memory controller. The results of the executing are transmitted to the agent.

### BACKGROUND OF THE INVENTION

The invention relates to operating a memory controller and in particular, to a method of dynamically selecting a page management policy for a memory controller.

When accessing semiconductor memory that is attached to a computer system, the memory controller must first open the page of memory containing the desired data before that data can be accessed. Page open access is defined as a memory access that remains within the memory page boundary (typically four kilobytes) of the last memory page access on the affected memory row. After the data has been obtained from the memory, that page can either be left open, or it can be closed. The memory controller's choice of which policy to utilize is called its “page management” policy.

If a subsequent access is to that same page in memory, performance is significantly improved by leaving that page of memory open, avoiding the latency and performance penalty of opening it again. Thus, the ideal page management policy for such a “sequential” access pattern, where there tend to be multiple sequential accesses to the same page of memory, is to keep the page open. This is called a “page-open” policy.

On the other hand, if the page-open policy is utilized and the next access is to another page in memory, then the page must first be closed and the second page must be opened before the next access to the other page in memory can be completed. (This description is simplified, because in practice a memory controller may maintain many open pages at a given time. However, this does not materially impact this discussion.) Thus, the page-open policy is not the best policy for access patterns where multiple sequential accesses are not to the same page of memory. For such a “random” access pattern, if a given page is closed after it has been accessed, then the next access only has to open the new page before the data can be accessed. Thus, better performance can be obtained for this “random” access pattern by closing a given page after it has been accessed. This is called a “page-close” policy.

The performance of a memory subsystem can be improved by adapting the page management policy to the access patterns of agents using that memory. Modern memory controllers do have mechanisms for changing the page management policy, however, the page management policy is usually manually selected at system initialization time, and is rarely changed once a system has been shipped. In many cases, the type of workload performed by the memory controller changes over time and the page management policy selected at system initialization may not always result in the best performance for the current workload.

### BRIEF SUMMARY OF THE INVENTION

One aspect of the invention is a method for operating a memory controller. The method includes receiving a current memory access request from an agent. A page management policy associated with that agent is determined in response to receiving the request. The memory controller is set to the page management policy associated with that agent and the current memory access request is executed by the memory controller. The results of the executing are transmitted to the agent.

Another aspect of the invention is a system for accessing system memory. The system includes a memory bank configured to support page accesses and a memory controller in communication with the memory bank and an agent. The memory controller includes instructions to implement a method including receiving a current memory access request from the agent, where the current memory access request includes a request to access data stored on the memory bank. The system also includes instructions for determining a page management policy associated with the agent in response to receiving the request. The memory controller is set to the page management policy associated with the agent and the current memory access request is executed by the memory controller, where the executing includes accessing a page on the memory bank. The results of the executing are transmitted to the agent.

A further aspect of the invention is a computer program product for operating a memory controller. The computer program product includes a storage medium readable by a processing circuit and storing instructions for execution by the processing circuit for performing a method that includes receiving a current memory access request from an agent. A page management policy associated with the agent is determined in response to receiving the request. The memory controller is set to the page management policy associated with the agent and the current memory access request is executed by the memory controller. The results of the executing are transmitted to the agent.

### BRIEF DESCRIPTION OF THE DRAWINGS

Referring now to the drawings wherein like elements are numbered alike in the several FIGURES:

FIG. 1 is a block diagram of a system that may be utilized to implement an exemplary embodiment of the present invention;

FIG. 2 is a flow diagram of a process for adjusting the page management policy in accordance with an exemplary embodiment of the present invention; and

FIG. 3 is a flow diagram of a process for dynamically adjusting the page management policy in accordance with an exemplary embodiment of the present invention.

### DETAILED DESCRIPTION

An exemplary embodiment of the present invention includes a method for dynamically adjusting the page management policy of a system controller (e.g., a memory controller) to achieve enhanced, and in some cases optimal performance as the system executes its intended workload. The adjustments can be based on a variety of indicators, ranging from real-time measurements of the sequential nature of the memory access patterns, to using one policy for central processing units (CPUs) and another for input/output (I/O) adapters. It is recognized that manipulation of page management policy has an impact on performance, but currently, setting up the appropriate policy is manually applied, often at the factory, and it is rarely changed in the field. An exemplary embodiment of the present invention includes a dynamic approach that may be utilized to adaptively enhance performance in real time in response to complex variations in workload characteristics.

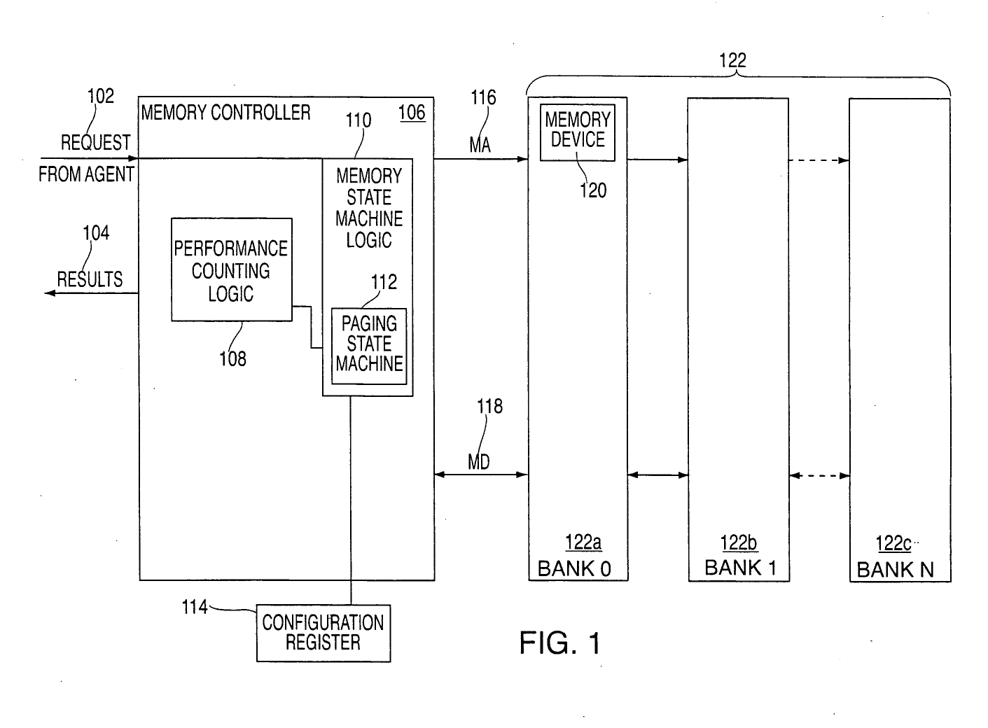

FIG. 1 depicts a memory controller 106 in communication with a system memory 122 that may be utilized to implement an exemplary embodiment of the present invention. The memory controller 106 receives requests 102, or accesses, from one or more agents (e.g., CPUs, I/O adapters, etc.). These requests 102, or accesses, are dispatched to the system memory 122 using various address, data and control signals. In an exemplary embodiment of the present invention, if a read request is issued, then the memory controller 106 dispatches the address on memory address (MA) signals 116 with the appropriate assertion of control signals, receives the read data from the selected memory bank on memory data (MD) signals 118, and provides the results 104 (e.g., data) to the requesting agent.

The system memory 122 depicted in FIG. 1 includes a plurality of memory banks. FIG. 1 illustrates memory banks 122a-c. However, no particular limitation is placed on the bank configuration. Each bank may include a plurality of memory devices 120 and each memory device 120 may be a physical memory chip. No limitation is placed by exemplary embodiments of the present invention on the number of memory devices 120 within each bank. The memory devices 120 may include any memory devices known in the art capable of supporting page mode addressing. For example, the memory devices 120 may be implemented by dynamic random access memory (DRAM), extended data out DRAM (or EDO DRAM) and/or synchronous DRAM (or SDRAM).

As is known in the art, a variety of signals may be utilized by the memory controller 106 to access data stored in the system memory 122. For example, in an exemplary embodiment of the present invention that includes SDRAM memory devices 120, the memory controller 106 also provides memory chip select (MCS) signals to the system memory 122. The MCS signals serve as chip selects or bank selects for memory banks 122a-c. For embodiments employing SDRAM devices, MCS signals are utilized to select the active bank. MCS signals may not be required for other embodiments. For example, regular asynchronous DRAM banks may be differentiated by row address strobe (RAS) signals.

As depicted in FIG. 1, the memory controller 106 provides MA signals 116 to the system memory 122. The memory controller 106 derives the MA signals 116 from the address provided by the requesting agent via the request 102. In response, the memory controller 106 multiplexes row and column addresses on the MA signals 116 to the system memory 122. A row address is provided on MA signals 116 followed by a column address or series of column addresses.

FIG. 1 also depicts data being transferred between the memory controller 106 and the system memory 122 on MD signals 118. For read operations, the memory controller 106 provides data on MD signals 118 to be written to the active memory bank at the address specified by the row and column address. The memory controller 106 transfers data to and from the various agents by receiving requests 102 and transmitting the results 104 of executing the requests 102.

The proper sequencing of the memory control signals is provided for by the memory state machine logic 110 within the memory controller 106. General configurations for state machines and logic to control the memory control signals such as RAS and column address strobes (CAS) for memory devices are well understood in the memory controller art. Therefore, the memory state machine logic 110 is not described in detail except with regard to what is necessary for an understanding of exemplary embodiments of the present invention. The memory state machine logic 110 supports a page open policy for accessing the system memory 122. The page-open policy refers to leaving a page open within a memory bank by leaving a row, defined by a row address, active within the bank. Subsequent accesses to the same row (page) may be serviced by providing only the column address, therefore avoiding the time associated with providing a row address. By leaving the page open the accesses may be completed more rapidly as long as accesses are “page hits,” that is, to the open page.

Page accessing may also be disabled in the memory controller 106 to implement a page-close policy where accessed pages are not left open. For regular DRAM, a page may be closed by unasserting a row address strobe (RAS). For SDRAM, a page may be closed either by a specific bank deactivate (precharge) command or by a read/write command that automatically closes the page upon completion of the access. When no page is open, the bank precharges so that the RAS precharge time for a given memory may be satisfied.

The paging state machine 112 controls whether or not the memory state machine logic 110 implements a page-open policy or a page-close policy when accessing the system memory 122. Typically, applications that access memory addresses sequentially will benefit from the page-open policy most, because they will have a high page hit ratio. However, some applications result in more random memory accesses and therefore have a lower page hit ratio. If an application has a poor page hit ratio, the memory controller may have to frequently be switching to new pages. Every time a new page is opened in the same bank, a precharge delay will be incurred. If the page hit ratio is poor, the page-open policy may actually decrease performance because of the additional precharge delay. It is understood that the paging state machine 112 is shown as a separate functional block for clarity. In actual implementation, the paging state machine 112 may be implemented as a separate state machine or as part of other control logic such as the memory control state machine and logic 110. The page state machine 112 and other functional blocks described herein need not be implemented as classic state machines or any other particular implementation. Any suitable circuit/logic implementation that performs the functions described herein may be utilized.

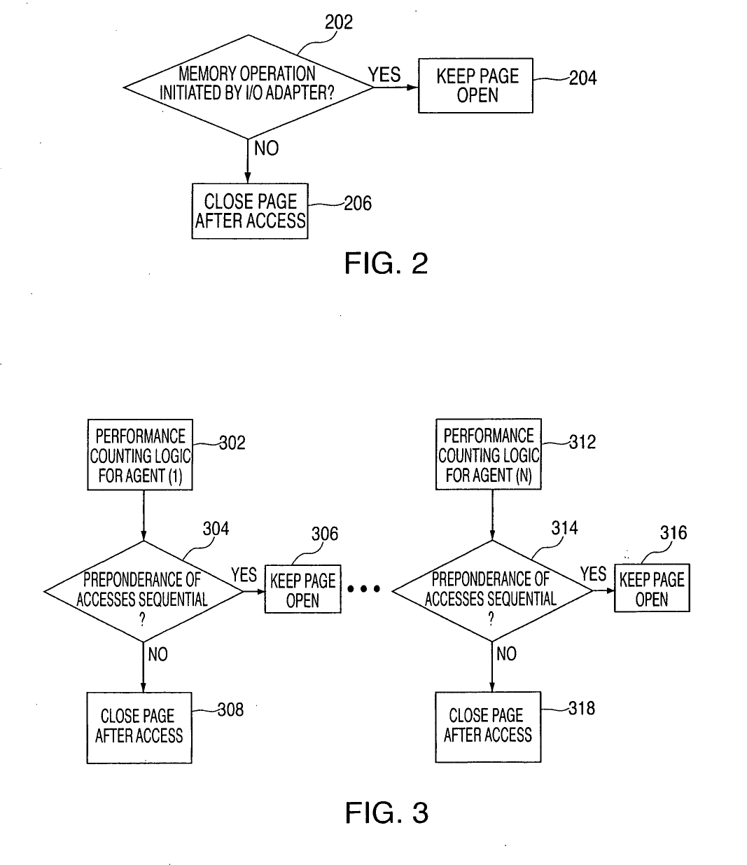

As depicted in FIG. 1, a configuration register 114 may be included in the system to provide mode select signal(s) to the paging state machine 112. The configuration register 114 may be a programmable storage location within the memory controller 106 or it may be a separate register as shown in FIG. 1. The configuration register 114 may be programmed by system or application software to cause the paging state machine 88 to select a page-open policy or a page-close policy for particular agents or groupings of agents. In addition, the configuration register 88 may be programmed by system or application software to select an adaptive paging policy that causes the paging state machine 112 to dynamically adjust the paging state for particular agents based on factors such as a previous access pattern as tracked by the performance counting logic 108. The processing performed by the paging state machine 112 and the performance counting logic 108 is described below in reference to FIGS. 2 and 3. The system in FIG. 1 is an example system configuration and any system configuration known in the art that support paging may be utilized by exemplary embodiments of the present invention.

FIG. 2 is a flow diagram of a process for adjusting the page management policy in accordance with an exemplary embodiment of the present invention. The algorithm depicted in FIG. 2 is based on the observation that for commercial server workloads, CPUs tend to have random access patterns and benefit most from a page-close policy. In contrast, I/O devices tend to stream data to sequential memory addresses and benefit most from a page-open policy. For this class of workload, the memory controller 106 may be statically set up to apply the appropriate page management policy based on the accessing agent (e.g., CPU, I/O adapter) generating the request 102. This algorithm may be extended to situations where different CPUs may have different access patterns, some random and some sequential, and have their per-agent page management policies set accordingly. It may also be extended to the case where I/O devices exhibit random access patterns and benefit from a page-closed policy, and CPUs may exhibit sequential access patterns and benefit from page-open policy, and in fact to support either mode of behavior for any device. In the subsequent discussion, it is assumed without loss of generality that I/O devices tend to stream data to sequential memory addresses and benefit most from a page-open policy, and CPUs tend to have random access patterns and benefit most from a page-close policy.

At step 202 in FIG. 2, it is determined whether the memory operation in the request 102 was initiated by an agent that is an I/O adapter. This determination may be made by logic contained in the memory controller 106. In an exemplary embodiment of the present invention, the logic is included in the memory state machine logic 110 which includes a look-up table that correlates unique agent identifiers with agent types. When the request 102 is received by the memory controller 106, the request includes an agent identifier that is utilized by the look-up table to determine the agent type. Next, step 204 is performed if the agent type is determined to be an I/O adapter. At step 204, the logic contained in the memory controller 106 utilizes the look-up table to determine the correct policy for the agent type of I/O adapter. In this example, an I/O adapter agent type correlates to a page-open policy and the logic sends a signal to the paging state machine 112 directing it to keep the page open after access. The look-up table may be updated by the configuration register 114 in response to a system or application program with the proper access authority.

Alternatively, step 206 is performed if the agent type is determined not to be an I/O adapter. At step 206, the logic contained in the memory controller 106 utilizes the look-up table to determine the correct policy for agents that are not I/O adapters. In this example, non-I/O adapters are assumed to be CPUs and the look-up table has specified a page-close policy for CPUs. The logic sends a signal to the paging state machine 112 directing it to close the page after access.

The process depicted in FIG. 2 can be readily adapted to other workload types. For example, if a system was to be used in a technical computing environment, where the CPU tends to access sequential memory addresses, the system could be set up with the following settings: if the access, or request 102, is from an I/O adapter (non-caching, non-symmetric agent) then keep the page open after access (i.e., page-open policy); and if the access is from a CPU (caching, symmetric agent) then keep the page open after access (i.e., page-open policy).

In an alternate exemplary embodiment of the present invention, the page-open or page-closed policy is determined based on a unique identifier associated with the agent so that not all CPUs or all I/O adapters are required to be associated with the same policy. For example, certain CPUs may require a page-open policy and other CPUs may require a page-close policy. This mix may be implemented by having an entry in the look-up table for each agent (e.g., the unique identifier) with a policy associated with each agent. Further, the logic and look-up table may be located in the memory controller 106, in the memory state machine logic 110, in the performance counting logic 108 or in a processor located remote to the memory controller 106 with access to both the request 102 and the paging state machine 112. In addition, as is known in the art, a variety of machine instructions and data structures may be utilized to implement the above process and alternate exemplary embodiments of the present invention are not limited to the logic and look-up table approach described previously.

FIG. 3 is a flow diagram of a process for dynamically adjusting the page management policy in accordance with an exemplary embodiment of the present invention. The process depicted in FIG. 3 dynamically adapts the page management policy for a particular agent to generate enhanced, and in some cases optimal performance for a mix of workloads by the agent. This is important because a given computer system's workload may vary significantly over time, and a page management policy that yields good performance at one time will yield poor performance at another time. At step 302, the performance counting logic 108 keeps track of the nature of previous requests 102 from individual agents (in this example agent (1)) to determine whether the accesses are sequential or non-sequential. Data relating to the nature of the requests may be obtained from the memory controller 106 (e.g., from the memory state machine logic 110). Based on this data, step 304 is performed to determine if a preponderance of the accesses by the agent are sequential, or to the same page. The performance counting logic 108 continuously estimates the likelihood, or probability, that sequential memory access will be to the same page, or to different pages. In an exemplary embodiment of the present invention this is performed by counting the number of sequential or closely spaced in time accesses to the same page divided by the total number of accesses over a given sample interval. In alternate embodiments, the likelihood that sequential memory access will be to the same page may be estimated based on other calculations such as whether the last two or more accesses were to the same page or to different pages. A separate set of performance counters is maintained and updated in the performance counting logic 108 for each agent that accesses the memory. The set of performance counters include counters that indicate each CPU's memory access sequentiality and other counters that indicate each I/O adapter's memory access sequentiality.

In an alternate exemplary embodiment of the present invention, where the memory controller 106 does not provide data that can be used to determine the page that was accessed in response to a request 102, other secondary measurements may be used to indicate system performance. These secondary indicators tend to be less accurate indicators but still provide some insight into memory access performance. The secondary indicators may include measurements such as memory bandwidth utilization, frontside bus (FSB) bandwidth utilization, and memory access latency. The page policy on the memory controller 106 can be adjusted in a closed-loop manner until these secondary indicators show that an enhanced performance has been reached.

Based on the measured memory access patterns (or the secondary measurements), the memory controller 106 dynamically manipulates the page management policy of the memory controller 106 in order to improve the system performance. At step 304 in FIG. 3, the performance counting logic 108 determines if the preponderance of accesses are sequential for a given agent (in this example, agent (1)). For example, if the performance counting logic 108 measures access stride and finds at step 304, that the preponderance of accesses from a given agent are sequential, then step 306 is performed and the memory controller 106 is set to a page-open policy for the given agent. In an exemplary embodiment of the present invention, this setting is performed by the logic in the performance counting logic 108 communicating a required page management policy for the current request 102 by the agent to the paging state machine 112.

Alternatively, if the performance counting logic, at step 304, finds that the preponderance of accesses, or requests 102, from a given agent are random, then step 308 is performed and the memory controller 106 is instructed to close pages as soon as the agent is done reading and/or writing to them (i.e., a page-close policy). In addition, the memory controller 106 can dynamically switch between these modes (page-open policy and page-close policy) as the workload varies with time. Because the performance counting logic 108 measures sequentially for each agent (i.e., CPU, I/O adapter, etc.) that accesses the system memory 122, the memory controller 106 can apply the policy that is best suited for that particular agent's current access pattern. As depicted in FIG. 3, in steps 312-318, this process of counting and determining the type of accesses is performed for each agent that may transmit requests 102 to the memory controller 106. In an alternate exemplary embodiment of the present invention, a subset of the agents that may transmit requests 102 to the memory controller utilize the process depicted in FIG. 3.

As an extension to the algorithm described in reference to FIG. 3, it may be beneficial to set up a given set of channels for sequential access and another set of channels for random access if the memory controller 106 supports several virtual channels to memory. Then, the pre-characterized accesses may be routed accordingly. In effect, the memory controller 106 dynamically assigns a transaction to a “sequential” channel based on whether it emanates from an adapter that tends to perform sequential accesses (i.e., is on an already open page), or to a “random” channel if it is from an agent that tends to perform random accesses (i.e., not on an already open page).

The computer instructions to implement the performance counting logic 108 may be located anywhere on the memory controller 106 or in a processor located remote to the memory controller 106 with access to the memory controller 106. It is also noted that both of the algorithms described in reference to FIGS. 2 and 3 apply not only to the main memory of a computer system, but to any level of a data management system's caching hierarchy that supports multiple page management policies.

An exemplary embodiment of the present invention includes an adaptive algorithm that provides improved performance regardless of whether the CPU streams data to sequential memory addresses, such as in the technical computing workload; accesses random memory addresses, as in the commercial server workload; or exhibits any combination of memory access patterns. An exemplary embodiment of the present invention dynamically and in real-time adapts the page management policy to workload where any agent (e.g., a CPU, an I/O adapter) might at one time stream data to sequential memory addresses and at another time access random pages in memory. This may lead to improved performance because the page management policy is not static and can adapt for each agent based on the type of accesses currently being requested by the agent.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for operating a memory controller, the method comprising:
receiving a current memory access request from an agent;
determining a page management policy associated with the agent in response to the receiving;
setting the memory controller to the page management policy associated with the agent;
executing the current memory access request on the memory controller; and
transmitting results of the executing to the agent.

2. The method of claim 1 wherein the page management policy is a page-open policy.

3. The method of claim 1 wherein the page management policy is a page-close policy.

4. The method of claim 1 wherein the current memory access request includes an agent type and the determining is responsive to the agent type.

5. The method of claim 4 wherein the agent type is a central processing unit or an input output adapter.

6. The method of claim 1 wherein the current memory access request includes an agent workload type and the determining is responsive to the agent workload type

7. The method of claim 1 wherein the current memory access request includes a unique identifier for the agent and the determining is responsive to the unique identifier.

8. The method of claim 1 wherein the determining a page management policy includes:
calculating a probability that a future memory access request by the agent will include access to a page accessed by the current memory access request; and
using the probability to determine the page management policy.

9. The method of claim 8 wherein the calculating is based on a history of memory access patterns associated with the agent.

10. The method of claim 8 wherein the probability is calculated based on a number of prior sequential memory access requests by the agent to a common page divided by a total number of prior memory access requests by the agent in a specified time interval.

11. The method of claim 8 wherein the probability is calculated based on a number of prior sequential memory access requests by the agent to a common page.

12. The method of claim 8 wherein the determining results in a page management policy of page-open if the probability is greater than or equal to a threshold value and a page management policy of page-close if the probability is less than the threshold value.

13. The method of claim 1 wherein the determining results in the page management policy being dynamically adapted based one or more prior memory accesses by the agent.

14. The method of claim 1 wherein the setting the memory controller is performed dynamically in response to the determining.

15. A system for accessing system memory, the system comprising:
a memory bank configured to support page accesses; and
a memory controller in communication with the memory bank and an agent, wherein the memory controller includes instructions to implement a method including:
receiving a current memory access request from the agent, wherein the current memory access request includes a request to access data stored on the memory bank;
determining a page management policy associated with the agent in response to the receiving;
setting the memory controller to the page management policy associated with the agent;
executing the current memory access request on the memory controller, wherein the executing includes accessing a page on the memory bank; and
transmitting results of the executing to the agent.

16. The system of claim 15 wherein the memory bank includes one or more memory devices.

17. The system of claim 15 wherein the memory devices include one or more of dynamic random access memory, extended data out dynamic random access memory and synchronous dynamic random access memory.

18. The system of claim 15 wherein the memory bank includes main memory.

19. A computer program product for operating a memory controller, the computer program product comprising:
a storage medium readable by a processing circuit and storing instructions for execution by the processing circuit for performing a method comprising:
receiving a current memory access request from an agent;
determining a page management policy associated with the agent in response to the receiving;
setting the memory controller to the page management policy associated with the agent;
executing the current memory access request on the memory controller; and
transmitting results of the executing to the agent.

20. The computer program product of claim 18 wherein the determining a page management policy includes:
calculating a probability that a future memory access request by the agent will include access to a page accessed by the current memory access request, wherein the calculating is based on a history of memory access patterns associated with the agent; and
using the probability to determine the page management policy.
